(19) United States
(12) Patent Application Publication
(10) Pub. No.: US 2017/0140754 A1
(43) Pub. Date: May 18, 2017

(54) DIALOGUE APPARATUS AND METHOD

(71) Applicant: KABUSHIKI KAISHA TOSHIBA, Tokyo (JP)

(72) Inventor: Yumi ICHIMURA, Abiko Chiba (JP)

(73) Assignee: KABUSHIKI KAISHA TOSHIBA, Tokyo (JP)

(21) Appl. No.: 15/421,392

(22) Filed: Jan. 31, 2017

Related U.S. Application Data
(63) Continuation of application No. PCT/JP2015/058562, filed on Mar. 20, 2015.

(51) Int. Cl. G10L 15/18; G10L 15/22; G10L 15/06; G10L 15/30

(52) U.S. Cl. CPC G10L 15/1815; G10L 15/30; G10L 15/22; G10L 15/063; G10L 2015/0635; G10L 2015/223

(57) ABSTRACT

According to one embodiment, a dialogue apparatus includes the following elements. The utterance database stores utterances and intentions. The model Generator generates a model for estimating an intention from the utterance database. The intention estimation unit estimates an intention of an utterance by referring to the model to generate an intention estimation result. The intention confirmation unit makes an inquiry to confirm a correct intention of the utterance in accordance with the intention estimation result. The utterance registration unit determines an intention of the utterance based on a response to the inquiry, and registers the utterance and the determined intention associated with the utterance in the utterance database.

### CROSS-REFERENCE TO RELATED APPLICATIONS

This application is a Continuation Application of PCT Application No. PCT/JP2015/058562, filed Mar. 20, 2015, the entire contents of which are incorporated herein by reference.

### FIELD

Embodiments described herein relate generally to dialogue apparatus and method.

### BACKGROUND

A conventional and-based dialogue system accepts only predetermined commands. In contrast, a voice dialogue application for smartphones, which is called a personal assistant, can accept natural speech inputs. For example, if a user says “It's too loud” when listening to music, the voice dialogue application. responds to the user's utterance by lowering the volume.

A dialogue system which accepts natural speech input is realized by preparing acceptable intentions in advance, and collecting variations of utterances corresponding to each of the intentions and creating a model to estimate an intention. However, costs are incurred in collecting a wide variety of utterances corresponding to intentions.

### BRIEF DESCRIPTION OF THE DRAWINGS

FIG. 1 is a block diagram schematically showing a dialogue system according to an embodiment.

FIG. 2 is a flowchart illustrating an example of the process performed by-the intention confirmation unit shown. in FIG. 1.

FIG. 3 is a flowchart illustrating an example of the process performed by the reworded sentence generator shown in FIG. 1.

FIG. 4A is a drawing showing an example of replacement rules included in the reword rule shown in FIG. 1.

FIG. 4B is a drawing showing an example of a give/receive-type verb replacement table included in the reword rule shown in FIG. 1.

FIG. 4C is a drawing showing an example of an intransitive/transitive-type verb replacement table included in the reword rule shown in FIG. 1.

FIG. 4D is a drawing showing an example of an antonymous verb table included in the reword rule shown in FIG. 1.

FIG. 4E is a drawing showing an example of an antonymous adjective table included in the reword rule shown in FIG. 1.

FIG. 4F is a drawing showing an example of a synonym table included in the reword rule shown in FIG. 1.

FIG. 5 is a flowchart illustrating an example of the process performed by the utterance registration unit shown in FIG. 1.

FIG. 6 is a drawing showing an example of the representative utterance table of the utterance registration unit shown in FIG. 1.

FIG. 7 is a drawing showing an example of the utterance database shown in FIG. 1.

### DETAILED DESCRIPTION

According to one embodiment, a dialogue apparatus includes an acquisition unit, an utterance database, a model generator, an intention estimation unit, an intention confirmation unit, and an utterance registration unit. The acquisition unit acquires an utterance. The utterance database stores utterances and intentions respectively corresponding to the utterances. The model generator generates a model for estimating an intention from the utterance database. The intention estimation unit estimates an intention of the utterance by referring to the model to generate a first intention estimation result. The intention confirmation unit makes an inquiry to confirm a correct intention of the utterance in accordance with the first intention estimation result. The utterance registration unit determines an intention of the utterance based on a response to the inquiry, and registers the utterance and the determined intention associated with the utterance in the utterance database.

Hereinafter, embodiments will be described with reference to the drawings.

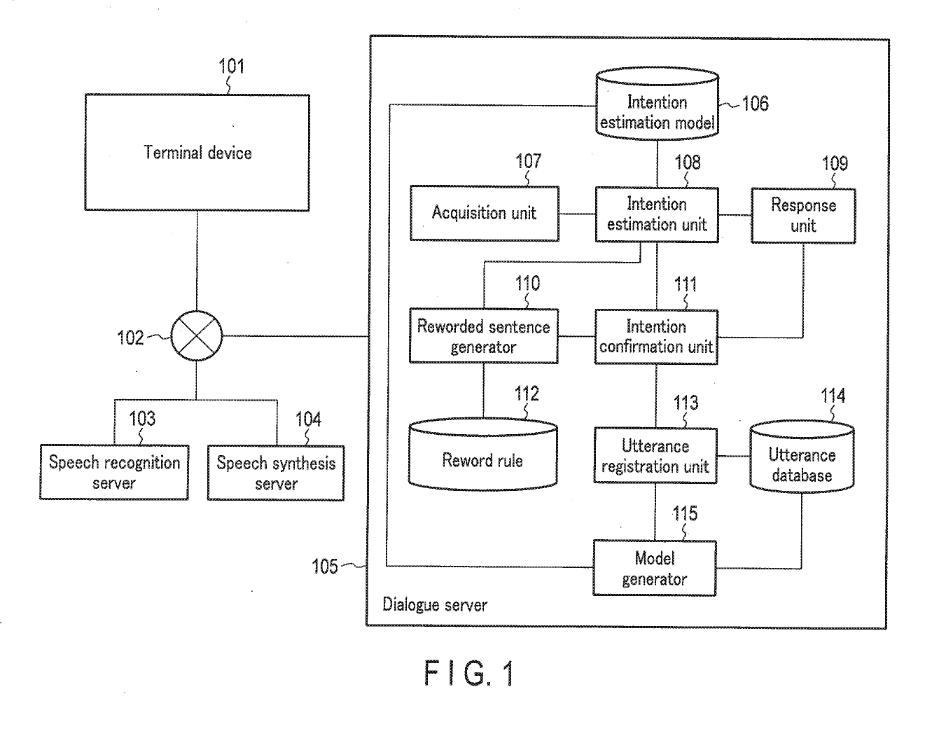

FIG. 1 schematically shows the dialogue system according to an embodiment. The dialogue system shown in FIG. 1 includes a terminal device 101 which is operated by a user, a speech recognition server 103 which performs speech recognition, a speech synthesis server 104 which performs speech synthesis, and a dialogue server 105 which performs dialogue control (also referred to as a dialogue apparatus). The terminal device 101, the speech recognition server 103, the speech synthesis server 104, and the dialogue server 105 are connected to network 102, such as an Internet and mobile phone network, and they can mutually communicate.

The terminal device 101 is a personal computer (PC) or a smartphone, for example. The terminal device 101 sends a user's utterance (a speech which is output from a user) to the speech recognition server 103 via network 102. The speech recognition server 103 converts the utterance received from the terminal device 101 into a text, and sends the text to the dialogue server 105 via network 102. The dialogue server 105 processes the utterance received from the speech recognition server 103, outputs a response to the utterance in the form of text, and sends the text to the speech synthesis server 104 via network 102. The speech synthesis server 104 converts the response received from the dialogue server 105 into speech sound and sends the speech sound to the terminal device 101 via network 102. The terminal device 101 outputs the speech sound received from the speech synthesis server 104. Thus, the user can interact with the dialogue server 105 by speech sound through the terminal device 101.

The dialogue server 105 includes an intention estimation model 106, an acquisition unit 107, an intention estimation unit 108, a response unit 109, a reworded sentence generator 110, an intention confirmation unit 111, a reword rule 112, an utterance registration unit 113, a speech database 114, and a model generator 115.

The acquisition unit 107 acquires a user's utterance. Specifically, the acquisition unit 107 receives an utterance which is input to the terminal apparatus 101 by a user and converted into a text by the speech recognition server 103.

The intention estimation unit 108 estimates an intention of the utterance acquired by the acquisition unit 107 by referring to the intention estimation model 106, which is a model for estimating an intention. For example, the intention estimation unit 108 outputs an intention estimation result, including a plurality of pairs of an intention and a certainty level of the intention. The intention included in the intention estimation result is a candidate of the intention of the utterance. Since estimation using a model is widely known, the explanation thereof is omitted.

The reworded sentence generator 110 generates a reworded sentence by rewording the utterance with a different expression by referring to the reword rule 112. For example, the reworded sentence generator 110 rewords the utterance with a different expression while retaining the meaning of the utterance. The reworded sentence generator 110 uses the intention estimation unit 108 to confirm whether it is possible to correctly estimate the intention of the reworded utterance. The process performed by the reworded sentence generator 110 will be described in detail later.

The intention confirmation unit 111 makes an inquiry to confirm a correct intention of the user's utterance in accordance with the intention estimation result which is output from the intention estimation unit 108. For example, the intention confirmation unit 111 activates the reworded sentence generator 110 as needed to acquire a reworded sentence, and makes an inquiry using the acquired reworded sentence. The process at the intention confirmation unit 111 will be described in detail later.

The response unit 109 outputs a response to the user's utterance. For example, the response unit 109 generates an inquiry sentence in accordance with instructions from the intention confirmation unit 11, and sends the inquiry sentence to the speech synthesis server 104 via network 102.

The utterance registration unit 113 determines an intention of the user's utterance and registers the utterance with the determined intention, which is associated with the utterance in the utterance database 114. For example, the utterance registration unit 113 determines an intention of the utterance based on a user's response to an inquiry. The process at the utterance registration unit 113 will be described in detail later.

The utterance database 114 stores a plurality of utterances and a plurality of intentions respectively corresponding thereto. The model generator 115 generates a model to estimate an intention (e.g., a statistical model) from the utterance database 114. Since the process of generating a model using machine learning is widely known, an explanation thereof is omitted. The model generator 115 generates a model at an appropriate timing. For example, model generation may be performed every time an utterance is registered in the utterance database 114, or may be periodically performed, or may be performed based on an operator's operation. The model generator 115 updates the intention estimation model 106 using the generated model; in other words, the model generator 115 sets the generated model as a new intention estimation model 106.

Next, the operation of the dialogue server 105 will be described.

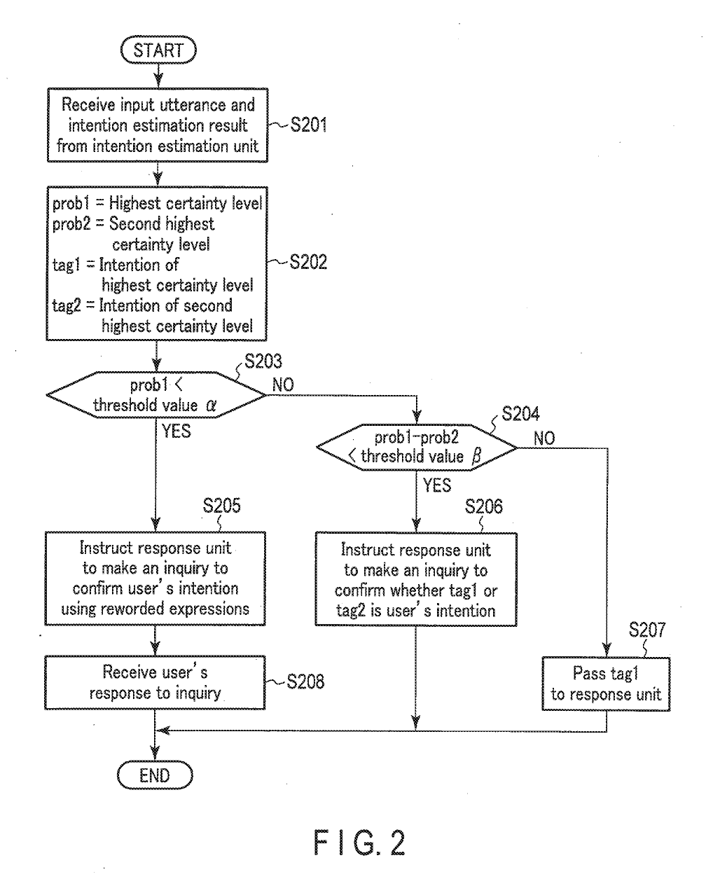

FIG. 2 shows an example of the operation at the intention confirmation unit 111. First, the acquisition unit 107 acquires the user's utterance, and the intention estimation unit 108 estimates an intention of the utterance. Herein, the utterance is called an input utterance.

In step S201 shown in FIG. 2, the intention confirmation unit 111 receives an input utterance and an intention estimation result of the input utterance from the intention estimation unit 108. The intention estimation result includes a plurality of pairs of a tag indicating an intention and a certainty level, as shown below. A certainty level may be expressed with a value from 0 to 1.

tag01:0.890

tag02:0.769

tag03:0.022

In this example, tag01, tag02, and tag03 placed before the colon are tags, and 0.890, 0.769, 0.022 placed after the colon are certainty levels.

In step S202, the intention confirmation unit 111 assigns the highest certainty level to the variable prob1 and the second highest certainty level to the variable prob2, and assigns an intention having the highest certainty to the variable tag1 and an intention having the second. highest certainty to the variable tag2.

In step S203, the intention confirmation unit 111 compares prob1 with a predetermined threshold value α. If prob 1 is smaller than the threshold value α, the process proceeds to step S205; if not, the process proceeds to step S204.

In step S204, the intention confirmation unit 111 compares a difference obtained. by subtracting prob 2 from prob 1 with a predefined threshold value β. If the difference is smaller than the threshold value β, the process proceeds to step S206; if not, the process proceeds to step S207.

If the process proceeds to step S205, in step S205, the intention confirmation unit 111 activates the reworded sentence generator 110, acquires a reworded sentence which is the input utterance reworded with different expressions, and instructs the response unit 109 to make an inquiry to confirm the intention of the input utterance using the reworded sentence.

If the process proceeds to step S206, in step S206, the intention confirmation unit 111 instructs the response unit 109 to make an inquiry confirm which of tag1 or tag2 is the intention of the input utterance.

In step S208, the intention confirmation unit 111 receives a user's response to the inquiry in step S205 or step 206 through the intention estimation unit 108, and the process herein is finished.

If the process proceeds to step S207, in step S207, the intention confirmation unit 111 passes tag1 to the response unit 109, and the process is finished herein.

The process at the intention confirmation unit 111 is thus finished.

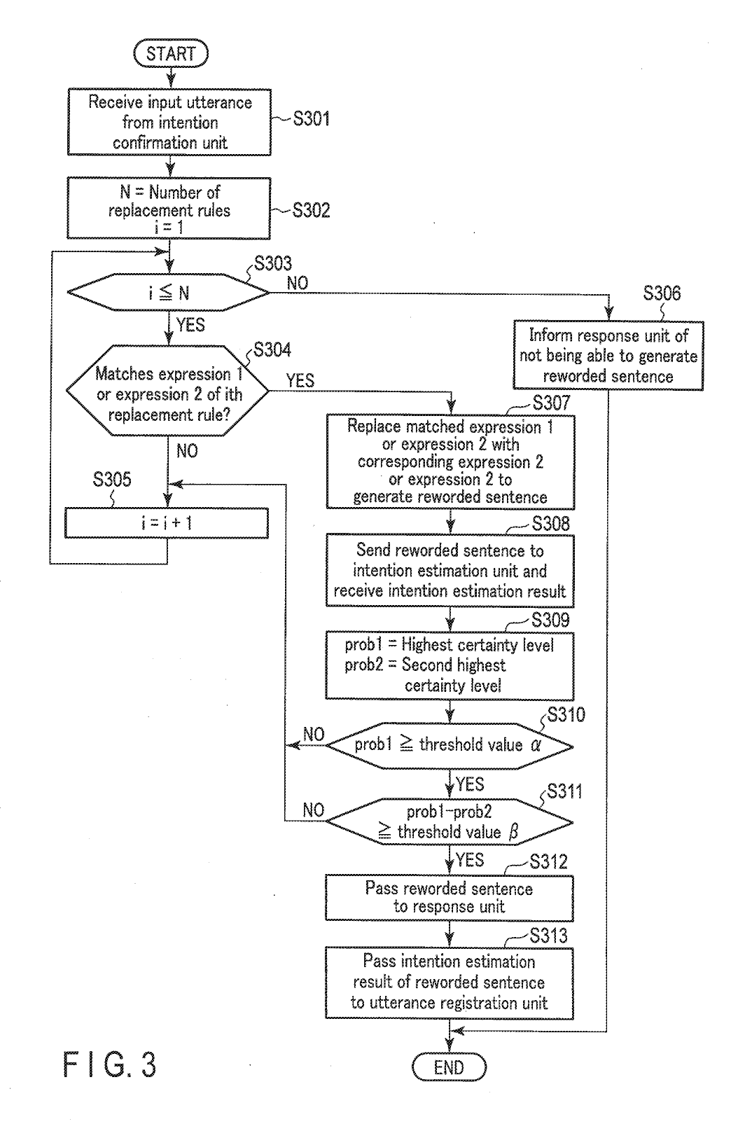

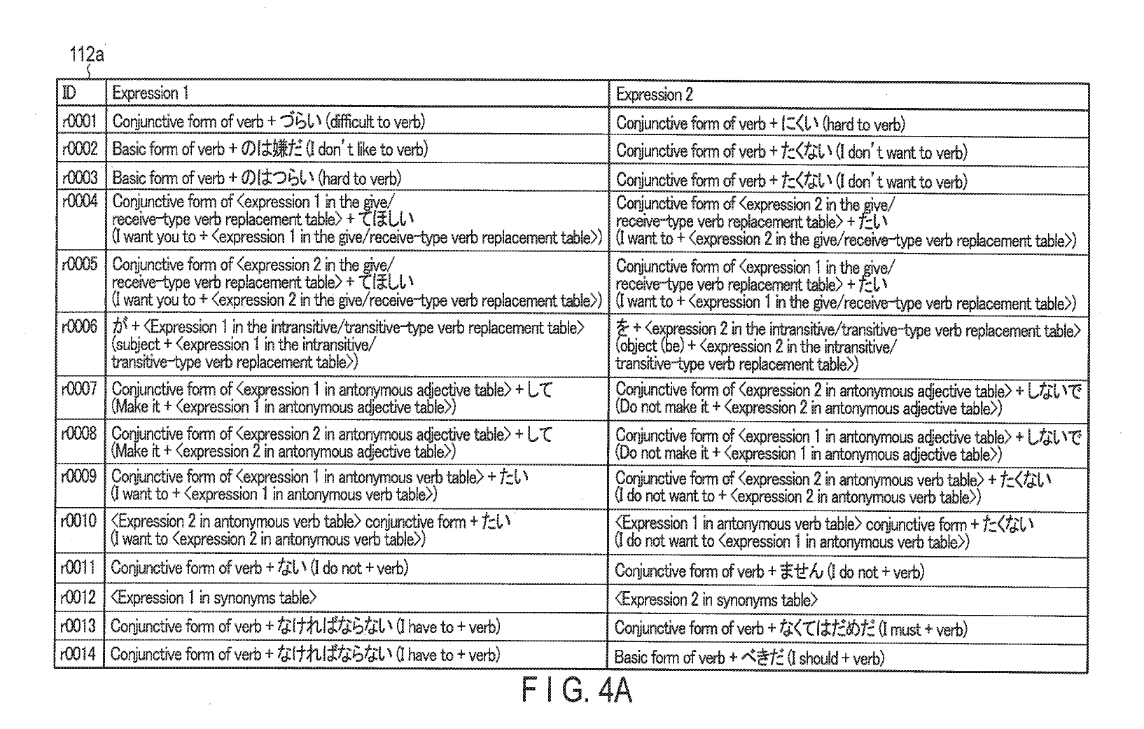

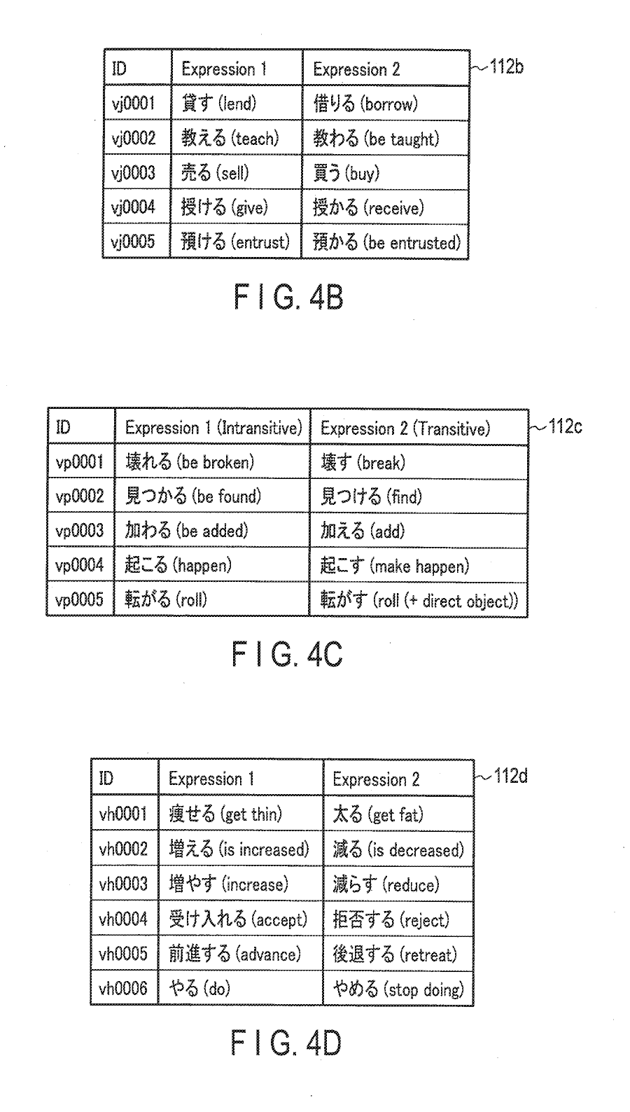

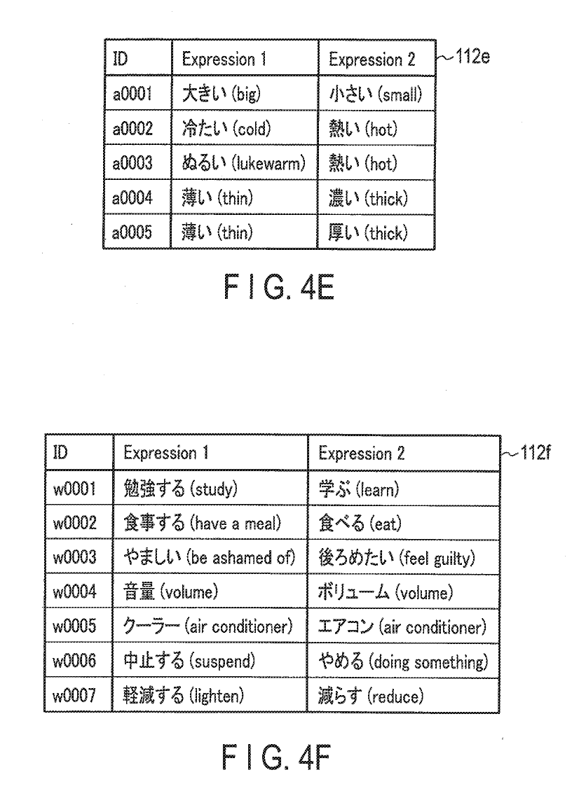

FIG. 3 shows an example of the operation at the reworded sentence generator 110, and FIG. 4A to FIG. 4F show an example of the reword rule 112. The reword rule 112 includes replacement rules 112a shown in FIG. 4A, a give/receive-type verb replacement table 112b shown in FIG. 4B, an intransitive/transitive-type verb replacement table 112c shown in FIG. 4C, an antonymous verb table 112d shown in FIG. 4D, an antonymous adjective table 112e shown in FIG. 4E, and a synonym table 112f shown in FIG. 4F. Each of the rules and tables includes an ID field, an Expression 1 field, and an Expression 2 field.

The replacement rules 112a are to replace a target with Expression 2 when the target matches Expression 1 and replace a target with Expression 1 when the target matches Expression 2. In the replacement rule with ID r0001, Expression 1 is “conjunctive form of verb+ [symbol] (difficult to+verb)” and Expression 2 is “conjunctive form of verb+ [symbol] (hard to+verb)”. An utterance “ [symbol] [symbol] (Bread is difficult to eat)” is used as an example. The expression “ [symbol] (difficult to eat)” matches Expression 1, the replacement generator 110 replaces “ [symbol] ” with “ [symbol] ”. Thus, a reworded sentence “ [symbol] (Bread is hard to eat)” can be acquired.

In the replacement rule with ID r0004, Expression 1 is “conjunctive form of <Expression 1 in the give/receive-type verb replacement table>+ [symbol] (want someone/something to <Expression 1 in the give/receive-type verb replacement table>)”, and Expression 2 is “conjunctive form of <Expression 2 in the give/receive-type verb replacement table>+ [symbol] (want to <Expression 2 in the give/receive-type verb replacement table>)”. An utterance “ [symbol] [symbol] (I want you to lend me some money)” is used as an example. The expression “ [symbol] (lend)” in “ [symbol] ” matches Expression 1 in vj0001 in the give/receive-type verb replacement table 12b; thus, the reworded sentence generator 110 replaces “ [symbol] ” with “ [symbol] (borrow)”, and replaces “ [symbol] (I want you to)” with “ [symbol] (I want to)”. As a result, “ [symbol] (I want you to lend me)” is replaced with “ [symbol] (I want to borrow)”, and a reworded sentence “ [symbol] (I want borrow some money)” can be acquired.

In step S301 in FIG. 3, the reworded sentence unit 110 receives an input utterance from the intention confirmation unit 111. In step S302, the reworded sentence generator 110 assigns the number of replacement rules stored in the reword rule 112 to the variable N, and assigns an initial value 1 to the variable i.

In step S303, the reworded sentence generator 110 determines whether i is not more than N. If i is not more than N, the process proceeds to step S304; otherwise, the process proceeds to step S306. In step S304, it is determined if the input utterance matches Expression 1 or Expression 2 of the ith replacement rule. If there is a match, the process proceeds to step S307; if not, the process proceeds to step S305. In step S305, the reword generator 110 increments the variable i by 1, and the process returns to step S303.

If the process proceeds to step S306, in step 306, the reworded sentence generator 110 informs the response unit 109 that a reworded sentence cannot be generated, and the process herein is finished.

If the process proceeds to step S307, in step S307, the reworded sentence generator 110 replaces Expression 1 or Expression 2 which matches the input utterance with a corresponding Expression 2 or 1 to generate a reworded sentence. In step S308, the reworded sentence generator 110 sends the reworded sentence to the intention estimation unit 108, and receives an intention estimation result of the reworded sentence from the intention estimation unit 108. The intention estimation result includes a plurality of pairs of a tag indicating an intention and a level of certainty.

In step S309, the reworded sentence generator 110 assigns a value of the highest certainty level to the variable prob1, and a value of the second highest certainty level to the variable prob2. In step S310, the reworded sentence generator 110 compares prob 1 with the predetermined threshold value α. If prob1 is equal to or greater than the threshold value α, the process proceeds to step S311; if not, the process proceeds to step S305. In step S311, a difference obtained by subtracting prob2 from prob1 is compared with the predetermined threshold value If the difference is equal to or greater than. the threshold value β, the process proceeds to step S312; if not, the process returns to step S305. The threshold values α and β in the reworded sentence generator 110 may be the same as or different from the threshold values α and β in the intention confirmation unit 111.

If the process proceeds to step S312, in step 312, the reworded sentence generator 110 passes the reworded sentence to the response unit 109. In step S313, the reworded sentence generator 110 passes the intention estimation result of the reworded sentence, and the process herein is finished.

The process at the reworded sentence generator 110 is thus finished.

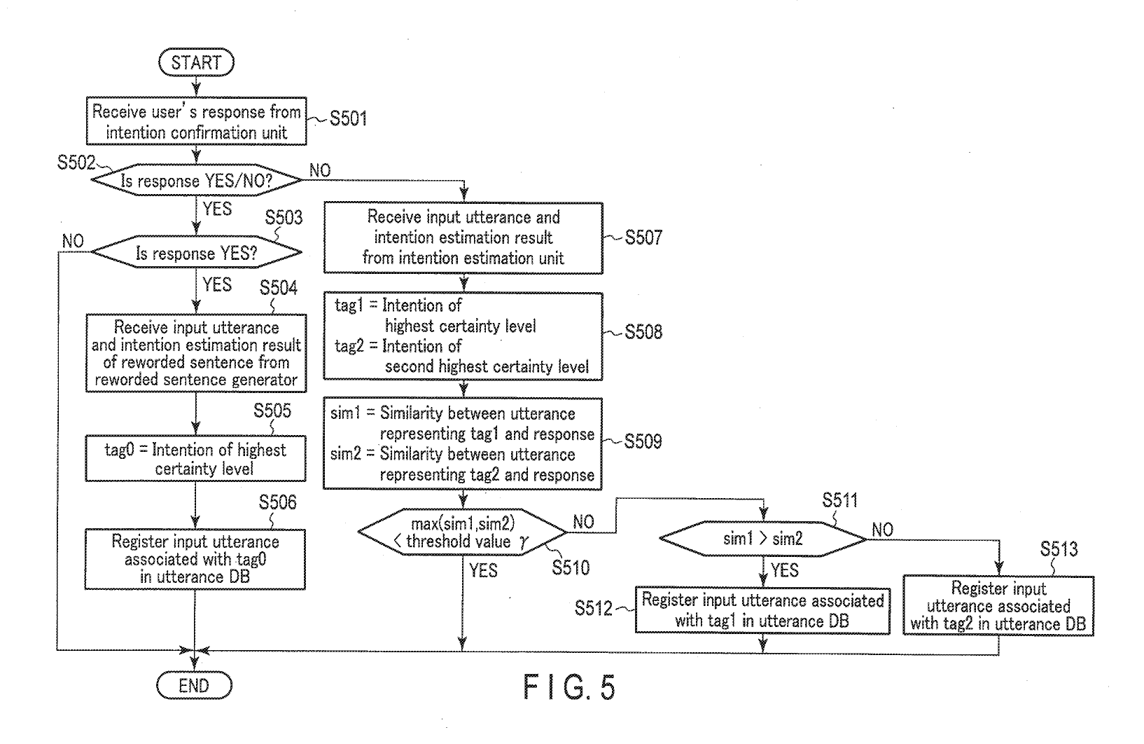

FIG. 5 illustrates an example of the operation performed by the utterance registration unit 113. in step S501 in FIG. 5, the utterance registration unit 113 receives a user's response to the inquiry (the inquiry indicated in step S205 or step S206 in FIG. 2) through the intention confirmation unit 111.

In step S502, the utterance registration unit 113 determines whether the received response is an utterance meaning YES or NO. For example, “ [symbol] (Yes)” or “ [symbol] (Yes, that's right)” is an utterance meaning YES, and “ [symbol] [symbol] (No)” or “ [symbol] (No, it's not)” is an utterance meaning NO. If the received response is an utterance meaning YES or NO, the process proceeds to step S503; if not, the process proceeds to step S507.

In step S503, the utterance registration unit 113 determines whether the received response is an utterance meaning YES (i.e., a positive utterance) or not. If the response is an utterance meaning YES, the process proceeds to step S504, and if the response is an utterance meaning NO (i.e., a negative utterance), the process herein is finished.

If the process proceeds to step S504. In step S504, the utterance registration unit 113 receives the input utterance (i.e., the utterance before being reworded) and the intention estimation result of the reworded sentence from the reworded sentence generator 110. In step S505, the utterance registration unit 113 assigns an intention having the highest certainty level included in the intention estimation result of the reworded sentence to the variable tag0. In step S506, the utterance registration unit 113 registers the input utterance associated with tag0 in the utterance database 114, and the process herein is finished.

In step S507, the utterance registration unit 113 receives the input utterance and the intention estimation result thereof from the intention estimation unit 108. In step S508, the utterance registration unit 113 assigns an intention having the highest certainty level included in the intention estimation result of the reworded sentence to the variable tag1, and assigns an intention having the second highest certainty level to the variable tag2.

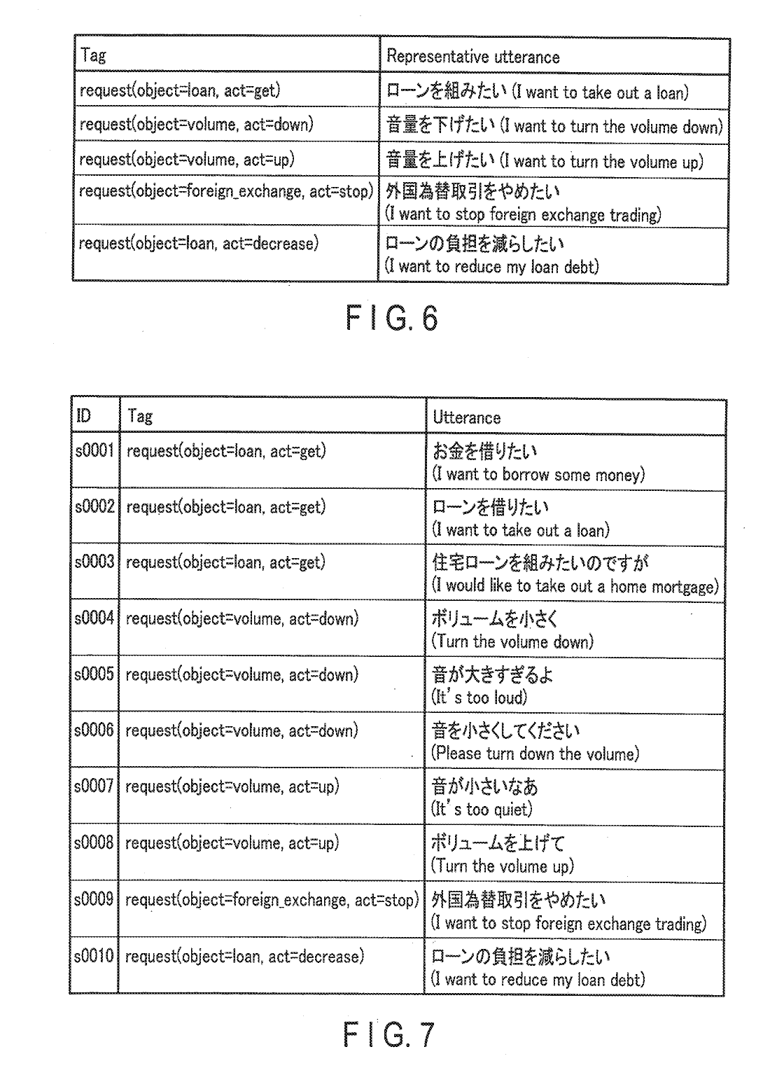

In step S509, the utterance registration unit 113 assigns the similarity between an utterance representing tag1 and the user's response to the variable sim1, and assigns the similarity between an utterance representing tag2 and the user's response to the variable sim2. For example, the utterance registration unit 113 has a representative utterance table in which a tag indicating an intention associated with a representative utterance, as shown in FIG. 6, and acquires representative utterances corresponding to tag1 and tag2 from the representative utterance table. A similarity level between sentences can be acquired by calculating a cosine similarity level between word vectors having words included in the sentences as elements.

In step S510, the utterance registration unit 113 compares a maximum value among sim1 and sim2 with a predetermined threshold value γ. If a maximum value among sim1 and sim2 is smaller than the predetermined threshold value γ, the process herein is finished; if not, the process proceeds to step S511.

In step S511, the utterance registration unit 113 compares sim1 with sim2. If sim1 is greater than sim2, the process proceeds to step S512; if not, the process proceeds to step S513.

If the process proceeds to step S512, in step S512 the utterance registration unit 113 registers the input utterance associated with the intention of tag1 in the utterance database 114, and the process herein is finished.

In step S513, the utterance registration unit 113 registers the input utterance associated with tag2 in the utterance database 114, and the process herein, is finished.

The process at the utterance registration unit 113 is thus finished.

By the above-described process, the utterance that was input by the user and associated with an intention is registered in the utterance database 114. FIG. 7 shows an example of the utterance database 114. The utterance database 114 includes an ID field, a field of a tag indicating an intention, and an utterance field. For example, the utterance data with ID s0001 is the tag request (object=loan, act=get), and the utterance is “ [symbol] [symbol] (I want to borrow some money)”.

Thus, the dialogue server 105 makes an inquiry to confirm an intention with a user when the intention of the utterance input by the user cannot be correctly estimated, and determines an intention based on the user's response to the inquiry. Thus, it is possible to collect an utterance associated with an appropriate intention. As a result, the cost of collecting utterances associated with intentions can be reduced, and the cost of generating a model for intention estimation can be reduced.

Next, a specific example of the operation at the dialogue system according to the present embodiment will be described.

Suppose if a user makes an utterance “ [symbol] [symbol] [symbol] (I would like you to lend me some money.)”. From the utterance, the following intention estimation results can be acquired:

request (object=loan, act=get):0.020

request (object=account, act=open):0.015

request (object=foreign_money, act=buy):0.011

Herein, the threshold α=0.030, and the threshold β=0.020. Since the highest certainty level 0.020 is smaller than the threshold value α, the reworded. sentence generator 110 is activated (step S205 in FIG. 2). The expression “ [symbol] [symbol] (lend)” in “ [symbol] [symbol] (I would like you to lend me some money)” matches Expression 1 with ID vj0001 in the give/receive-type verb replacement table 112b shown in FIG. 4B; thus, the reworded sentence generator 110 acquires “ [symbol] borrow)”. The expression “ [symbol] (would like you to lend me)” matches Expression 1 with ID r0004 in the replacement rules 112a shown in FIG. 4A; thus, the reworded sentence generator 110 acquires “ [symbol] (I want to borrow)”. The reworded sentence unit 110 acquires a reworded sentence “ [symbol] [symbol] (I would like to borrow some money)” (step S307 in FIG. 3). The intention estimation unit 108 acquires the following intention estimation result from the reworded sentence “ [symbol] [symbol] (I would like to borrow some money)” (step S308 in FIG. 3).

request (object=loan, act=get):0.850

request (object=account, act=open):0.015

request (object=foreign_money, act=buy):0.011

Since the highest certainty 0.850 is greater than the threshold. value a and a difference between the highest certainty 0.850 and the second highest certainty 0.015 is greater than the threshold value β, the reworded sentence is passed to the response unit 109 (step S312 in FIG. 3). The response unit 109 makes an inquiry to, ask “ [symbol] [symbol] , [symbol] [symbol] [symbol] [symbol] , [symbol] [symbol] ? (I'm sorry, but I could not understand what you said. Did you mean to say you would like to borrow some money?)”, using the reworded sentence. If a user answered to this inquiry with “ [symbol] (Yes)”, the utterance which was initially input, “ [symbol] [symbol] (I would like you to lend me some money)” is associated with request (object=loan, act=get)which is an intention of “ [symbol] [symbol] (I would like to borrow some money)” and registers it in the utterance database 114.

Another example is described. Suppose if a user says “ [symbol] [symbol] (I want you to turn up the volume)”. From the utterance, the following intention estimation results can be acquired:

request (object=volume, act=up):0.795

request (object=volume, act=down):0.790

request (object=power, act=on):0.011

Similarly to the foregoing example, the threshold value α=0.030, and the threshold value β=0.020. The highest certainty level 0.795 is larger than the threshold value α, and the difference between the first highest certainty level 0.795 and the second highest certainty level 0.790, i.e., 0.005, is smaller than the threshold value β. In this case, the intention. confirmation unit 111 instructs the response unit 109 to make an inquiry to confirm which of request (object=volume, act=up) and request (object=volume, act=down) is the user's intention (step S206 in FIG. 2). The response unit 109 makes an inquiry to ask “ [symbol] , [symbol] [symbol] [symbol] [symbol] [symbol] [symbol] [symbol] ? (I+m sorry, but your statement may not have been correctly understood. Would you like to turn up the volume or down?)”, using the representative utterances associated with tags “request (object=volume, act=up)” and “request (object=volume, act=down)”. If a user answers “ [symbol] (I want to turn up the volume)”, a similarity level between “ [symbol] ” and “ [symbol] (turn up the volume)” or between “ [symbol] ” and “ [symbol] (turn down the volume)” is calculated (step S510 and step S511 in FIG. 5). In this case, the similarity level of “ [symbol] (turn up the volume)” is higher than the similarity level “ [symbol] [symbol] (turn down the volume)”. As a result, the utterance registration unit 113 registers request (object=volume, act=up) as an intention indicating “ [symbol] [symbol] (turn up the volume)” in the utterance database 114, associating the tag with the utterance which was initially input, “ [symbol] [symbol] (I want you to turn up the volume)”.

Another separate example will be described. Suppose if a user says “ [symbol] [symbol] (I do not want to do foreign exchange trading)” or “ [symbol] [symbol] (I want to suspend foreign exchange trading)”. If neither of the utterances is registered in the utterance database 114, it is highly possible that the certainty level of the intention estimation results of those utterances is less than the threshold value, and thus, the intention estimation for the utterances will fail. According to the antonymous verb table 112d in FIG. 4D, “ [symbol] (do)” is an antonym of “ [symbol] (stop doing)”, and according to the synonym table 112f, “ [symbol] (suspend)” is a synonym of “ [symbol] [symbol] (stop doing)”. By applying the rule r0010 or r0012 in the replacement rules 112a, a reworded sentence “ [symbol] [symbol] (I want to stop doing foreign exchange trading)” can be acquired for both of the utterances. If an utterance that is the same as this reworded sentence is registered in the utterance database 114, the certainty level of an intention estimation result for the reworded sentence is likely to be higher than the threshold value. If the certainty level is higher than the threshold value, the response unit 109 uses the reworded sentence to make an inquiry, like “ [symbol] [symbol] , [symbol] [symbol] [symbol] [symbol] [symbol] ? (I'm sorry, but your statement could not be understood. Did you mean to say you want to stop doing foreign exchange trading?)”. If the user returns a positive response, an intention of the utterance which was initially input, “ [symbol] [symbol] [symbol] (I do not want to do foreign exchange trading)” or “ [symbol] [symbol] [symbol] (I want to suspend foreign exchange trading)”, can be correctly estimated. Furthermore, the utterances are associated with correct intentions and registered in the utterance database 114, and the intention estimation model 106 is updated. Thus, after this, the intention of the utterance “ [symbol] [symbol] (I do not want to do foreign exchange trading)” or “ [symbol] [symbol] (I want suspend foreign exchange trading)” can he correctly estimated at. the time of the first intention estimation.

Another further example is described. Suppose if a user says “ [symbol] [symbol] (I want to lighten my loan debt)” or “ [symbol] [symbol] (I don't want to increase my loan debt)”. Even in a case where neither of the utterances is registered in the utterance database 114, if the utterance “ [symbol] [symbol] (I want to reduce my loan debt)” is registered, an intention of the input utterance can be correctly estimated by applying the reword rule 112. Furthermore, the utterances are associated with correct intentions and registered in the utterance database 114, and the intention estimation model 106 is updated. Thus, after this, the intention of the utterance “ [symbol] [symbol] (I want to lighten my loan debt)” or “ [symbol] [symbol] (I don't want to increase my loan debt)” can be correctly estimated at the time of performing the intention estimation for the first time.

In the present embodiment, an example of generating a reworded sentence from an original sentence (an input utterance) by applying one of the following rules, (1) a replacement rule using a pair of synonymous expressions related to auxiliary verbs or functional expressions equivalent to auxiliary verbs, (2) a replacement rule using a pair of synonymous expressions related to nouns, verbs, adjectives, or adjectival nouns, (3) a replacement rule using a pair of antonyms related to nouns, verbs, adjectives, or adjectival nouns, and (4) a replacement rule using a pair of verbs changing the give-and-receive relationship or changing between intransitive and transitive; however, a combination of the rules (1) to (4) can be applied, or the same rule can be applied several times.

In the present embodiment, the terminal device 101, the speech recognition server 103, the speech synthesis server 104, and the dialogue server 105 are utilized through network 102; however, the dialogue system may be realized as a system that inputs a text or outputs a text, without utilizing the speech recognition server 103 or the speech synthesis server 104. The system may be configured to operate all of, or any of the speech recognition server 103, the speech synthesis server 104, and the dialogue server 105 on the terminal device 101.

The instructions included in the steps described in the foregoing embodiment can be implemented based on a software program. A general-purpose computer system may store the program beforehand and read the program in order to attain the same advantage as the dialogue server of the foregoing embodiment. The instructions described in the foregoing embodiment are stored. in a magnetic disc (flexible disc, hard disc, etc.), an optical disc (CD-ROM, CD-R, CD-RW, DVD-ROM, DV±R, DVD±RW, etc.), a semiconductor memory, or a similar storage medium, as a program. executable by a computer. As long as the storage medium is readable by a computer or by an embedded system, any storage format can be used. An operation similar to the operation of the dialogue server of the foregoing embodiment can be realized, if a computer reads a program from the storage medium and executes the instructions described in the program on the CPU on the basis of the program. The computer may, of course, acquire or read the program by way of a network. Furthermore, an operating system (OS) working on a computer, database management software, middleware (MW) of a network, etc. may execute a part of processes for realizing the present embodiments based on instructions from a program installed from a storage medium onto a computer and an embedded system.

Furthermore, the storage medium according to the present embodiments is not limited to a medium independent from a system or an embedded system; a storage medium storing or temporarily storing a program downloaded through LAN or the Internet, etc. is also included as the storage medium according to the present embodiments.

In addition, the storage medium employed in the embodiments is not limited to a single storage medium. Multiple storage mediums may be employed to execute the processes of the embodiments. The storage medium or mediums may be of any configuration.

The computer or embedded system in the present embodiments are used to execute each process disclosed in the present embodiments based on a program stored in a storage medium, and the computer or embedded system may be an apparatus consisting of a personal computer or a microcomputer, etc. or a system, etc. in which a plurality of apparatuses are connected through network.

The computer adopted in the present embodiments is not limited to a personal computer; it may be a calculation processing apparatus, a microcomputer, etc. included in an information processor, and a device and apparatus that can realize the functions disclosed in the present embodiments by a program.

While certain embodiments have been described, these embodiments have been presented by way of example only, and are not intended to limit the scope. Indeed, the novel embodiments described herein may be embodied in a variety of other forms; furthermore, various omissions, substitutions and changes in the form of the embodiments described herein may be made without departing from the spirit. The accompanying claims and their equivalents are intended to cover such forms or modifications as would fall within the scope and spirit.

What is claimed is:

1. A dialogue apparatus comprising;
an acquisition unit which acquires an utterance;
an utterance database which stores utterances and. intentions respectively corresponding to the utterances;
a model generator which generates a model for estimating an intention from the utterance database;
an intention estimation unit which estimates an intention of the utterance by referring to the model to generate a first intention estimation result;
an intention confirmation unit which makes an inquiry to confirm a correct intention of the utterance in accordance with the first intention estimation result; and
an utterance registration unit which determines an intention of the utterance based on a response to the inquiry, and registers the utterance and the determined intention associated with the utterance the utterance database.

2. The dialogue apparatus according to claim 1, further comprising a reworded sentence generator which generates a reworded sentence which is the utterance reworded with a different expression,
wherein the first intention estimation result includes candidate intentions and first certainty levels respectively corresponding to the candidate intentions,
the intention confirmation unit makes an inquiry using the reworded sentence when a highest first certainty level is smaller than a threshold value, and
the utterance registration unit determines a candidate intention having the highest first certainty level as an intention of the utterance when the response to the inquiry is positive.

3. The dialogue apparatus according to claim 2, wherein the reworded sentence generator generates the reworded sentence while maintaining a meaning of the utterance by referring to a replacement rule using a pair of synonymous expressions related to auxiliary verbs or functional expressions equivalent to auxiliary verbs and replacing a part of the utterance with a different expression.

4. The dialogue apparatus according to claim 2, wherein the reworded sentence generator generates the reworded sentence while maintaining a meaning of the utterance by referring to a replacement rule using a pair of synonyms related to nouns, verbs, adjectives, or adjectival nouns, and replacing a part of the utterance with a different expression.

5. The dialogue apparatus according to claim 2, wherein the reworded sentence generator generates the reworded sentence while maintaining a meaning of the utterance by referring to a replacement rule using a pair of antonyms related to nouns, verbs, adjectives, or adjectival nouns, and replacing a part of the utterance with different expressions.

6. The dialogue apparatus according to claim 2, wherein the reworded sentence generator generates the reworded sentence while maintaining a meaning of the utterance by referring to a replacement rule using a pair of verbs having a give/receive relationship or an intransitive/transitive relationship and replacing a part of the utterance with a different expression.

7. The dialogue apparatus according to claim 1,
wherein the first intention estimation result includes candidate intentions and certainty levels respectively corresponding to the candidate intentions,
the intention confirmation unit makes an inquiry to confirm which of a candidate intention having a highest certainty level and a candidate intention having a second highest certainty level is a correct intention when a value obtained by subtracting the second highest certainty level from the highest certainty level is smaller than a threshold value, and
the utterance registration unit determines either one of the candidate intention having the highest certainty level or the candidate intention having the second highest certainty level as an intention of the utterance, as designated by a response to the inquiry.

8. The dialogue apparatus according to claim 1, further comprising a reworded sentence generator which generates a reworded sentence which is the utterance reworded with a different expression,
wherein the first intention estimation result includes first candidate intentions and first certainty levels respectively corresponding to the first candidate intentions,
the intention estimation unit estimates an intention of the reworded sentence by referring to the model to generate a second intention estimation result, the second intention estimation result including second candidate intentions and second certainty levels respectively corresponding to the second candidate intentions,
the intention confirmation unit makes an inquiry using the reworded sentence when a value obtained by subtracting a second highest second certainty level from a highest second certainty level is smaller than a threshold value, and
the utterance registration unit determines a second candidate intention having a highest second certainty level as an intention of the utterance when the response to the inquiry is positive.

9. A dialogue method comprising:
acquiring an utterance;
generating a model for estimating an intention from a utterance database which stores utterances and intentions respectively corresponding to the utterances;
estimating an intention of the utterance by referring to the model to generate a first intention estimation result;
making an inquiry to confirm a correct intention of the utterance in accordance with the first intention estimation result;
determining an intention of the utterance based on a response to the inquiry; and
registering the utterance and the determined intention associated with the utterance in the utterance database.

10. The dialogue method according to claim 9, further comprising generating a reworded sentence which is the utterance reworded with a different expression,
wherein the first intention estimation result. includes candidate intentions and first certainty levels respectively corresponding to the candidate intentions,
the making the inquiry comprises making an inquiry using the reworded sentence when a highest first certainty level is smaller than a threshold value, and
the determining the intention of the utterance comprises determining a candidate intention having the highest first certainty level as an intention of the utterance when the response to the inquiry is positive.

11. The dialogue method according to claim 10, wherein the generating the reworded sentence comprises generating the reworded sentence while maintaining a meaning of the utterance by referring to a replacement rule using a pair of synonymous expressions related to auxiliary verbs or functional expressions equivalent to auxiliary verbs and replacing a part of the utterance with a different expression.

12. The dialogue method according to claim 10, wherein the generating the reworded sentence comprises generating the reworded. sentence while maintaining a meaning of the utterance by referring to a replacement rule using a pair of synonyms related to nouns, verbs, adjectives, or adjectival nouns, and replacing a part of the utterance with a different expression.

13. The dialogue method according to claim 10, wherein the generating the reworded sentence comprises generating the reworded sentence while maintaining a meaning of the utterance by referring to a replacement rule using a pair of antonyms related to nouns, verbs, adjectives, or adjectival nouns, and replacing a part of the utterance with different expressions.

14. The dialogue method according to claim 10, wherein the generating the reworded sentence comprises generating the reworded sentence while maintaining a meaning of the utterance by referring to a replacement rule using a pair of verbs having a give/receive relationship or an intransitive/transitive relationship and replacing a part of the utterance with a different expression.

15. The dialogue method according to claim 9,
wherein the first intention estimation result includes candidate intentions and certainty levels respectively corresponding to the candidate intentions,
the making the inquiry comprises making an inquiry to confirm which of a candidate intention having a highest certainty level and a candidate intention having a second highest certainty level is a correct intention when a value obtained by subtracting the second highest certainty level from the highest certainty level is smaller than a threshold value, and
the determining the intention of the utterance comprises determining, either one of the candidate intention having the highest certainty level or the candidate intention having the second highest certainty level as an intention of the utterance, as designated by a response to the inquiry.

16. The dialogue method according to claim 9, further comprising generating a reworded sentence which is the utterance reworded with a different expression,
wherein the first intention estimation result includes first candidate intentions and first certainty levels respectively corresponding to the first candidate intentions,
the method comprises estimating an intention of the reworded sentence by referring to the model to generate a second intention estimation result, the second intention estimation result including second candidate intentions and second certainty levels respectively corresponding to the second candidate intentions,
the making the inquiry comprises making an inquiry using the reworded sentence when a value obtained by subtracting a second highest second certainty level from a highest second certainty level is smaller than a threshold value, and
the determining the intention of the utterance comprises determining a second candidate intention having a highest second certainty level as an intention of the utterance when the response to the inquiry is positive.

17. A non-transitory computer readable medium including computer executable instructions, wherein the instructions, when executed by a processor, cause the processor to perform a method comprising:
acquiring an utterance;
generating a model for estimating an intention from a utterance database which stores utterances and intentions respectively corresponding to the utterances;
estimating an intention of the utterance by referring to the model to generate a first intention estimation result;
making an inquiry to confirm a correct intention of the utterance in accordance with the first intention estimation result;
determining an intention of the utterance based on a response to the inquiry; and
registering the utterance and the determined intention associated with the utterance in the utterance database.
